(19) United States
(12) Patent Application Publication
(10) Pub. No.: US 2007/0160764 A1
(43) Pub. Date: Jul. 12, 2007

(54) Method and device for the application of at least two chemically different flowing media

(75) Inventors: Oral Aydin, Mannheim (DE); Andree Dragon, Speyer (DE); Stefan Kirsch, Nieder-Olm (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/588,213

(22) PCT Filed: Feb. 16, 2005
(86) PCT No.: PCT/EP05/01559

§ 371 Date: Aug. 2, 2006

(30) Foreign Application Priority Data
Feb. 18, 2004 (DE) 10 2004 007 927.7

(51) Int. Cl. B05D 3/12

(52) U.S. Cl. 427/355

(57) ABSTRACT

The invention relates to a process for applying at least two chemically different, flowable media, particularly solutions of polymers, dispersions or combinations thereof as adhesives, coating materials or coatings. By means of a multiple cascade die 1 at least two chemically different, flowable media 30, 32 are applied to web-form substrates 20; 40, 41 continuously in one operation. The total amount within a multilayer application 51 is between 2 g per m² to 200 g per m². The ratio of the individual layers 31, 33 within the multilayer application 51 to one another is between 0.1 to 100.

The invention relates to a process and to apparatus for applying at least two chemically different flowable media, particularly aqueous solutions of polymers, dispersions or combinations thereof, which can be used as adhesives and coating materials or as coatings, and to their use.

U.S. Pat. No. 5,665,163 relates to a film applicator with air exhaust. A uniform film of coating is applied at high speed to a substrate, in a papermaking machine or a calender, for example. Designed for that purpose is a converging wedge, additionally an adjustable converging wedge, and an extraction channel located between the two wedge-shaped sections. This solution minimizes the hydrodynamic instabilities and also reduces the effects of variable flows associated with a nonuniform feed and a dynamic contact line. The coating device additionally removes entrained air and excess coating material from the application zone, in order to stabilize the application conditions and to improve the machine's operating conditions.

U.S. Pat. No. 5,366,551 relates to a coating apparatus for conveyed web-form material. The coating device contains a pressurized channel in which a stream of the coating liquid first comes into contact with the substrate. The fluid for coating enters the channel and wets the substrate as it flows in the same direction in which the substrate is conveyed. A doctor element is provided at the downstream side of the channel, at which excess fluid in the channel is conveyed out of the channel along the contour of the doctor element. The geometry of the streamlined boundaries of the applicator prevents the formation of recirculating vortices and the like. The prevention of the incidence of vortices reduces the incidence of instabilities due to centrifugal forces and reduces harmful pressure fluctuations which might result in nonuniform coat weights. The prevention of the incidence of recirculating vortices and the like further prevents the development of air pockets or air bubbles, which might considerably impair the quality of coating and might result in coat weight nonuniformities and the development of streaks.

U.S. Pat. No. 5,735,957 describes a dual chamber arrangement for applying filmlike coatings, with an overflow device. An applicator head is arranged beneath a backing roll and comprises a housing divided into three sections. A first section is defined between an overflow barrier and a first side wall. A converging plate extends between the first wall and a second wall, and converges toward the substrate. A second section is formed between the plate and an end wall. Coating takes place within the two sections. A zone of low pressure is designed between the converging plate and the first wall and the second wall. The cavity opens toward the second section and draws air and excess coating material from the second zone. The substrate for coating is prewetted as it passes through the first zone, and a coating deprived of entrained air is applied to the substrate within the second zone. Coat weight uniformity and increased machine speed are achieved in this way.

WO 00/20123 relates to an apparatus for and a method of applying a flowable medium onto a moving surface. It discloses an apparatus for applying a flowable medium from a stock chamber to a surface being moved along the apparatus, and to the use of an apparatus of this type. The stock chamber partly covers the surfaces, with formation of a sealing gap and an exit gap. In order to avoid the formation of air bubbles and air pockets in the medium it is proposed to divide the stock chamber into a prechamber and a main chamber. A dividing element, which may be designed as a doctor element, and which together with the surface limits a dividing gap is arranged between the chambers. Various shapes of dividing elements are proposed. The apparatus is particularly suitable for applying a polymer dispersion to a moving surface. Also described is a method of operating an apparatus of this type. In accordance with the method proposed in WO 00/20123 the pressure of the medium to be applied is set higher in the prechamber than the pressure of the medium in the main chamber.

From “Perspektiven für die Verarbeitung von Dispersionshaftklebstoffen”, document TI/ET 1654 d, BASF Ludwigshafen, August 1993, J. Tü,uml rk, H. Fietzeck, H. Hesse and I. Voges, it is known to pressurize adhesive in a stock chamber with suitable means. By virtue of such pressurization the complete filling of engraved grooves is ensured even at high roll revolution speeds. Depending on the set pressure, a different amount of the adhesive is conveyed from the applicator at the exit gap even on the surface of the roll outside the engraved grooves. In this way it is possible for the amount of adhesive applied to the roll and hence, ultimately, the copeweight of the adhesive on the web that is to be coated to be set within a wide range without employing pressure. A further result of the higher pressure in the stock chamber is that only a greatly reduced quantity of air is introduced into the stock vessel at the sealing gap and it is possible in this way to counteract excessive foaming.

The higher the roll revolution speed is chosen, however, the higher must be the chosen pressure in the stock chamber in order effectively to avoid the introduction of air into the adhesive. The maximum attainable roll revolution speed, however, is limited by the fact that, when the pressure is increased further, the adhesive is forced uncontrollably on the one hand through the sealing gap and on the other through the exit gap from the stock vessel. The emergence of adhesives through the sealing gap results in an unwanted supply of adhesives upstream of this gap, which can lead to contamination of the surroundings of the applicator and, in extreme cases, to plant disruption. Uncontrolled emergence of adhesive through the exit gap leads for its part to nonuniform coat application to the web that is to be coated with the adhesive.

From the publication “Trends in der Haftmaterialindustrie”, Dr. Rüdiger Panzer, Herma GmbH, DE-Filderstadt, p. 4, FIG. 10 it is known to use curtain coating in order to coat pressure-sensitive dispersion adhesives for speeds of up to more than 500 m/min. Material emerging from a die of slot design is applied in the form of a curtain to a substrate, such as paper, which is moving past the stationary die. The exit die is located in a certain height above the substrate moving past the die. By means of curtain coating it is possible to realize high coating speeds in conjunction with uniform coating application. A further advantage cited is that there is low mechanical stress on the substrate to be coated. In order to achieve effective drying of the aqueous adhesives at speeds of up to 1500 m/min it is necessary to employ high-performance driers. The publication “Silikon-Haftkleberanlage mit 1000 m/min., Herausforderungen an einen Lieferanten von Beschichtungsmaschinen”, Ernst Meier, Bachofen+Meier A G, C H-Bulach, Section B6 (applicator for pressure-sensitive dispersion adhesives) discloses a high-speed curtain coater. A slot die of high-precision manufacture is installed at a distance of several centimeters, with a product web which runs horizontally. The coating material emerges as a free curtain from the exit cross section of the die, thereby making it possible to achieve a structureless, coherent and uniform coating on the product web moving in the horizontal direction, i.e. the substrate to be coated. With a coating method of this kind it is possible to achieve very high transverse profile qualities. On the one hand it is possible to minimize the application rate, thereby making it possible to lower the drying performance. This considerably reduces production costs. In addition it is possible to achieve an excellent coating appearance, i.e. a very smooth, structureless surface; moreover, there are no film fragmentation effects. Over and above these qualities, said method makes it possible to achieve a simple change in application weight by way of the control of the pump speed. Furthermore, the quantity of coating material in circulation is very small and the soiling tendency is low.

The publication “Curtain Coating Technology”, Dr. Peter M. Schweizer, Polytype discloses a slotted cascade die and also multiple cascade die. Using the slotted cascade die depicted in FIG. 1a of said publication it is possible to apply two fluids, which at an emergence point of the exit channels can be applied as a unified film to a substrate. From the slotted arrangement depicted in FIG. 1b it is possible for three different fluids to emerge, which through the force of gravity, for example, impinge from a height of between 50 and 300 mm onto the material moving past the die, e.g. a product web. With the version designed in slot form it is possible to apply up to 3 layers simultaneously, while with that in FIG. 1b of the abovementioned publication up to 10 layers can be applied in one pass.

The publication “Premetered and Simultaneous Multilayer Technologies”, Dr. Peter M. Schweizer, Polytype shows design versions of a multiple cascade die with which a plurality of layers can be applied simultaneously to a rotating, curved surface, such as the jacket of a roll, for example.

In light of the prior art depicted, the object on which the invention is based is to apply two flowable but chemically different media to moving surfaces in one operation, it being possible, among other things, for the media to react with one another and for high coating speeds to be achieved onto a substrate which is in web form: for example, the application of dispersions to a substrate in order to produce laminates.

In accordance with the invention the object is achieved by means of the features of claim 1 of the patent.

By means of the solution proposed in accordance with the invention, namely to apply at least two chemically different flowable media such as aqueous solutions of polymers, dispersions or combinations thereof, for example, using a multiple cascade die which has at least two outlets it is possible to produce adhesive systems and paints and also coatings. The total amount of the media emerging from the multiple cascade die, which is of at least two-stage design, is between 2 to 200 g/m², it being possible for the ratio of the individual layers to one another to be varied between 0.1 and 100. In that way it is possible, for example, to apply an extremely thin adhesive layer to a backing layer, with both layers emerging simultaneously to two-dimensional layer kind, one atop the other and continuously, from the cascade die of at least two-stage design and coming to lie atop the web-form substrate moving at high speed past the exit apertures of the multiple cascade die.

The process proposed in accordance with the invention can be used to laminate composite films and high-gloss films or to apply a self-adhesive system to web-form substrates such as paper or films or the like, for example. The proposed process can additionally be used to coat web-form substrates such as paper or polymeric films or else to coat metallized surfaces, in which case the layer facing the surface may serve to improve the adhesion or else as a barrier coat.

By virtue of the process proposed in accordance with the invention it is possible to provide substrates with paint films, the paint films having a multicoat layer construction owing to the multiple cascade die. Accordingly it is possible to apply elastic and hard layers to a substrate in one pass, the hard layer forming the upper layer, i.e. the outer layer.

Owing to the design of the multiple cascade dies with at least two exit stages it is possible, for example, to apply even cationic and anionic polymers, which on mixing normally gel or coagulate, without problems.

Additionally it is possible with the process proposed in accordance with the invention to apply solutions of polyvalent metal salts and metal complexes with polymer dispersions in one pass. This can take place by means of a separate layer application.

In one of the chemically different media, i.e. layers to be applied by way of the multiple cascade die, it is possible for polyisocyanates, polyepoxides or polyacyridines to be applied with another layer, which comprises dispersions, in one pass. The systems to which this relates may also be solutions of the reactive products, mentioned above, which are normally used as crosslinkers. As a result of the cascade die of at least 2-stage design it is possible for chemically different dispersions to be applied as individual layers in one pass, such as S/B dispersions (styrene/butadiene dispersions), acrylate, ethylene, vinylacetate dispersions and polyurethane dispersions, wax emulsions or, for example, silicone emulsions as release coat. The release coat serves as an antistick layer.

### DRAWING

The solution proposed in accordance with the invention is described in more detail below, with reference to the drawing, in which

FIG. 1 shows a multiple cascade die in schematic view,

FIG. 2 shows films of two flowable, chemically different media, with the film thickness shown greatly enlarged,

FIG. 3 shows an adhesive system, comprising an adhesive layer and a barrier layer between two backing substrates,

FIG. 4.1 shows a multiple cascade die for film application to a curved cylinder surface moving past the multiple cascade die,

FIG. 4.2 shows the design variant of a multiple cascade die whose multilayer casting film travels a drop height before application to a horizontally conveyed substrate, and

FIG. 4.3 shows the design variant of a multiple cascade die for applying two media, which leave the multiple cascade die from a joint exit on its bottom side.

### DESIGN VARIANTS

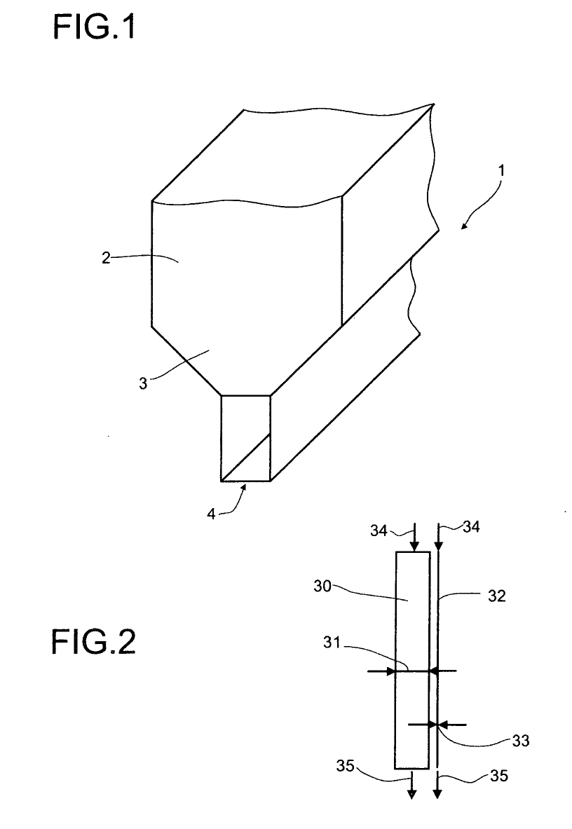

FIG. 1 shows a multiple cascade die in a schematic reproduction.

The multiple cascade die 1 shown in FIG. 1 is a die which comprises a container section 2 and a hopper section 3. Below the hopper section 3 there adjoins a channel which is tapered in cross section, extends widthwise vertically to the plane of the drawing, and is adjoined at its bottom end by a first exit cross section 4 for the coating material. The first exit cross section 4 shown in FIG. 1 can be an exit cross section at which coating flows emerging from the hopper section 3 are combined simultaneously and impinge jointly on the web-form substrate which is not shown in FIG. 1 but which is moving below the first exit cross section 4 of the multiple cascade die 1.

Apparent from the drawing according to FIG. 2 are two flowable but chemically different media which emerge simultaneously from a multiple cascade die 1. A first flowable medium 30 leaves the exit cross section in a multiple cascade die with a film thickness 31. The casting direction in which the first flowable medium 30 emerges from the multiple cascade die 1 is indicated by reference numeral 34; the flow direction or dropping direction 35 of the first flowable medium 30 is indicated by reference numeral 35. Viewed in the flow direction 35, the first flowable medium 30 impinges on the top of a web-form substrate which is moving beneath a multiple cascade die 1, such as a paper or film web substrate, for example.

Simultaneously with the first flowable medium 30 there emerges from the exit cross section of the multiple cascade die 1a second, further flowable medium 32. The film thickness with which the second flowable medium 32 leaves the multiple cascade die 1 is marked by reference numeral 33 and is a number of orders of magnitude below the film thickness 31 with which the first flowable medium 30 leaves the multiple cascade die 1.

The first flowable medium 30 and the second flowable medium 32, chemically different from the first flowable medium 30, emerge jointly in casting direction 34 from the exit cross section of the multiple cascade die 1 and, as viewed in the casting direction or dropping direction 35, impinge on the top of a web-form substrate, which is not shown in FIG. 2.

The flowable but chemically different media 30 and 32 shown in FIG. 2 are, in particular, aqueous solutions of polymers, dispersions or combinations thereof, which are employed as adhesives, paints or coatings. The two film sections of the first and second flowable media 30, 32, shown in greatly enlarged form in FIG. 2, are applied continuously to web-form substrates by means of the multiple cascade die 1 in one pass, the total amount of such a multilayer application being between 2 g per m² and 200 g per m². The ratio of the film thicknesses 31 and 33 within the multilayer application to one another is between 0.1 to 100 and is dependent on the particular application.

By means of the two flowable but chemically different media 30, 32 it is possible to laminate composite films or high-gloss films or to provide web-form substrates with an adhesive quality. The web-form substrate comprises, in particular, paper, film or metallized surfaces. The layer facing the surface of the substrate to be coated serves to improve the adhesion or as a barrier coat.

By means of the multiplayer application shown in schematic form in FIG. 2 it is possible to paint substrates or to apply elastic and hard layers jointly in one pass to a web-form substrate. With the aid of the process proposed it is possible in particular to apply two layers of cationic or anionic polymers, which may tend to gel or coagulate in the course of layering, jointly in one pass. These layers are in particular a combination of cationic polymer solutions with anionic dispersions. It is possible to apply solutions of polyvalent metal salts or metal complexes with polymer dispersions in one pass in multilayer applications to a web-form substrate or to a curved cylinder surface which is moving relative to the multiple cascade die, such as the surface of a roll, for instance.

In one of the chemically different media 30 and 32 it is possible to combine polyisocyanate, polyepoxides or polyacyridines with another layer, which in particular comprises dispersions.

It is additionally possible to apply solutions of crosslinked, reactive products to the top of a web-form substrate such as a paper web or a film web.

The flowable but chemically different media 30 and 32 areone-pass-appliable S/B dispersions, acrylate, ethylene/VAC dispersions and also polyurethane dispersions, wax emulsions or silicone emulsions as a release coat, alone or in combinations with one another.

It is also possible—cf. drawing according to FIG. 2—to apply the second flowable medium 32 in an extremely thin film to a release coat in order to improve wettability.

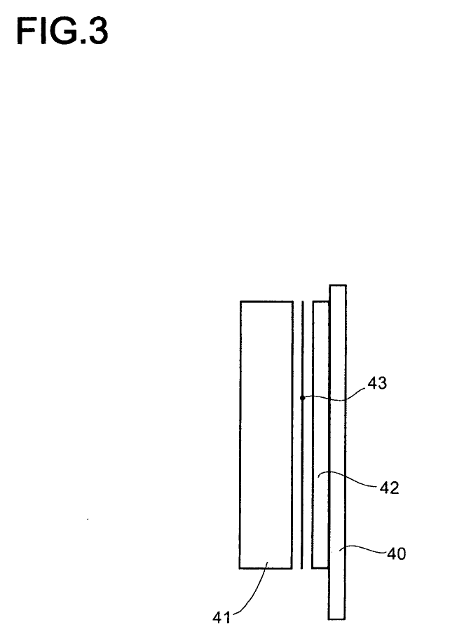

FIG. 3 shows an adhesive system comprising a first backing substrate 1, in the form for example of a paper web. Opposite said substrate 1 there is a second web-form backing substrate 41, which may likewise be in the form of a paper web or a film web. Between the first backing substrate 40 and the second backing substrate 41 there are an adhesive layer 42 and a barrier layer 43.

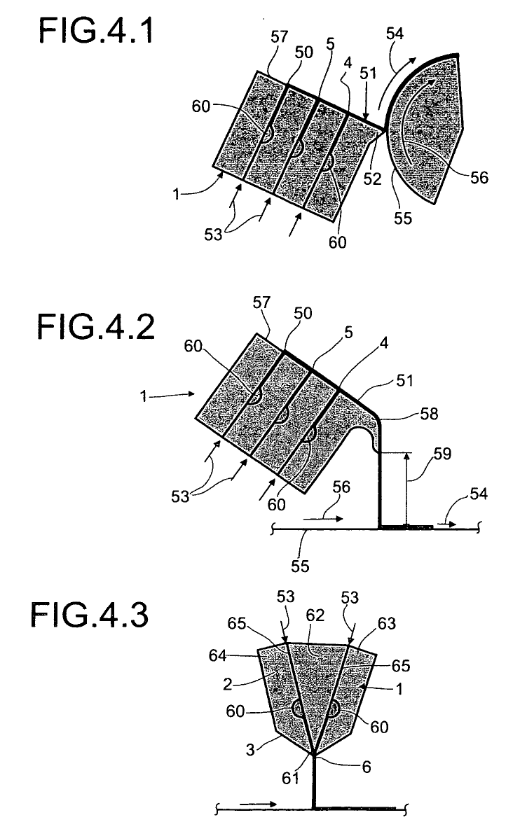

FIG. 4.1 shows a multiple cascade die which applies a multilayer coating material to the surface of a roll.

The multiple cascade die 1 comprises a plurality of storage channels 60 for accommodating chemically different flowable media. Each of the storage channels 60 is supplied by its own supply line 53 with coating material. The respective coating materials emerge from the multiple cascade die 1 at a first exit cross section 4, a second exit cross section 5 and a third exit cross section 50 onto a flat face 57 of said die 1, and form a film with a multilayer construction. This film moves along the flat face 57 of the multiple cascade die 1 toward a support wedge 52, which in the representation of FIG. 4.1 is placed alongside a rotating curved surface 55. The rotating curved surface 55 can be, for example, the roll cylinder of a driven roll. The curved surface 55 rotating in direction 56 picks up multilayer film 51 flowing from the flat face 57 of the multiple cascade die 1 and removes said film 51, by virtue of the rotation of the surface 55 in direction 56, in a takeoff direction 54.

Because of the construction of the multiple cascade die 1 the individual storage channels 60 are separate from one another. Each of the coating materials which can be processed in the multiple cascade die 1 of FIG. 4.1 is assigned its own exit cross section, 4, 5 or 50, so that the individual coating materials do not combine until they emerge from the exit cross sections 4, 5, 50 on the flat face 57 of the multiple cascade die 1, to form a multilayer film 51, and are taken off as a multilayer film 51 on the support wedge 52 in takeoff direction 54.

The design variant of a multiple cascade die that is illustrated in FIG. 4.2 shows that the multiple cascade die 1 in this design variant as well comprises a plurality of mutually separate storage channels 60. Each of the storage channels 60 is supplied with a coating material via its own supply line 53. The coating materials entering the multiple cascade die 1 through the supply lines 53 may be aqueous solutions of polymeric dispersions or combinations thereof for preparing adhesives, paints and coatings. As a result of the design of the multiple cascade die 1 as shown in FIG. 4.1 and in FIG. 4.2 it is possible for elastic and hard layers to be applied jointly in one pass. The number of layers which can be produced, which can be applied in a multilayer film 51 in one pass to a curved surface 55 or to a product web passing the multiple cascade die 1 horizontally, respectively, is dependent on the number of storage channels 60 from which the individual, layer-forming, flowable but chemically different media emerge from the storage channels 60. With the multiple cascade dies 1 shown in FIG. 4.1 and 4.2, for example, multilayer films 51 having three layers can be produced.

The chemically different but flowable media stored in each of the storage channels 60 emerge from their respective exit cross sections 4, 5 and 50 on the flat face 57 of the multiple cascade die 1 and combine to form the multilayer film 51. This film flows under the effect of gravity on the flat face 57 of the multiple cascade die, downward as shown in FIG. 4.2, and is deflected by a projection in the form of a support rounding 58. From the support rounding 58 the multilayer film 51 flows off as a film curtain and, under the effect of gravity, after traveling a drop height 59, impinges on the top of a product web 55 which is to be coated and which passes by relative to the multiple cascade die 1. The product web 55 is moving in conveying direction 56, so that after traveling the drop height 59 the multilayer film 51 is taken off by the continuous product web 55 in takeoff direction 54. As the multilayer film 51 is taken off after traveling the drop height 59, a uniform but multilayer coating film is formed on the top of the product web 55 moving in conveying direction 56. Depending on film thickness (see the drawing in FIG. 2) the individual layers, i.e., the films of the multilayer film 51, are not mixed and can therefore be applied simultaneously in one pass but essentially without mixing to the top of the product web 55 moving in conveying direction 56. This enables on the one hand a compactly constructed application combination, for producing, for example, adhesive systems while foregoing silicone applicator mechanisms and the like. The prior art drying devices, which take up a considerable amount of room, can be made smaller.

The representation of FIG. 4.3 shows a further design variant of a multiple cascade die 1. The multiple cascade die 1 depicted in FIG. 5.3 comprises a middle section 62 of wedge-shaped construction and also a first side section 63 and a second side section 64. The first side section 63 and the second side section 64 abut bearing surfaces 65 of the middle section 62, of wedge-shaped construction, of the multiple cascade die 1. Between the bearing surfaces 65 of the middle section 62 and the areas of the side sections 63 and 64 that face them there are, on the one hand, the supply lines 53 and, on the other hand, the channels which extend out from the storage channels 60 to a channel aperture 61.

With the design variant of the multiple cascade die 1 depicted in FIG. 4.3 it is possible to apply two chemically different but flowable media as a film, via a joint exit cross section 6, to the top of a product web 55 which is moving in conveying direction 56. After traveling the drop height 59 from the channel aperture 61 down to the top of the product web 55, which is moving horizontally along the multiple cascade die 1, the multilayer film 51, which in this case is of two-layer construction, is picked up in takeoff direction 54 by the top of the product web 55, on whose top it forms a coating of uniform construction.

With the multiple cascade die 1 shown in FIG. 4.3 it is possible, for example, to apply the first and second flowable media 30 and 32 shown in FIG. 2 to the top of the product web 55 in different film thicknesses 31 and 33 respectively. The flowable media 30 and 32 emerging in different film thicknesses 31 and 33, respectively, from, the joint exit cross section 6 emerge in casting direction 34 from the joint exit cross section 6 of the multiple cascade die 1 and flow in direction 35 toward the top of a product web which is moving horizontally along past the multiple cascade die 1. The ratio of the film thickness 31 of the first flowable medium 30 to the film thickness 33 of the second flowable medium 32 can vary in the range between 0.2 to 100 and can be adjusted according to requirements. Referring back to the illustration of FIG. 2, it is noted that the first flowable medium 30 is applied, for example, in a film thickness 31 of 20 μm and on its side supports the second flowable medium 32, which is applied for example in a film thickness 33 of approximately 2 μm. Both flowable media, 30 and 32, flow off simultaneously from the joint exit cross section 6, for example, on the underside of the channel aperture 61 of the multiple cascade die 1, as shown in FIG. 4.3, and impinge on the top of the material web 55 passing horizontally past the channel aperture 61. Said web 55 takes off the multilayer film 51 of—for example—two-layer construction shown in FIG. 2, in takeoff direction 54.

With the different design variants of a multiple cascade die 1 shown in FIGS. 4.1, 4.2 and 4.3 respectively it is possible to laminate composite films and high-gloss films or to provide web-form substrates such as polymeric or paper webs 55, for example, with an adhesive quality, by applying an adhesive system. In particular it is possible to coat web-form substrates, such as paper webs, polymeric films or metallized surfaces, with the layer facing the surface acting to improve the adhesion or as a barrier coat.

By means of the multiple cascade die 1, with which at least two flowable but chemically different media can be processed, it is possible, depending on the number of storage channels 60, to apply two, three, four, five or more different coating materials as a multilayer film 51 to a substrate 55 which is in web form for example. Elastic and hard layers can be applied to the substrate 55 in one pass in accordance with the charging of the storage channels 60 with appropriate components. Thus, with particular advantage, two layers of cationic and anionic polymers which would tend to gel or coagulate on layering can be applied to the web-form substrate 55 in one pass by means of the solution proposed in accordance with the invention. The total amount of the multilayer application achieved by forming a multilayer film 51 can be varied, depending on the requirements and desired layer thickness, between 2 g per m² and 200 g per m². The proportion of particularly outstanding results is obtained when the ratio of the individual layers within the multilayer film 51 to one another is between 0.1 and 100. The two flowable media 30 and 32 which can be applied to the web-form substrate 55 by way, for example, of the multiple cascade die 1 shown in FIG. 4.3 may be, for example, a combination of cationic polymer solutions in anionic dispersions. It is additionally possible to prepare solutions of polyvalent metal salts or metal complexes with polymer dispersions. The at least two chemically different media which are flowable may polyisocyanates, polyepoxides or polyacyridines with another layer which comprises dispersions, are applied in combination with one another simultaneously in one pass. It is equally possible to apply solutions of reactive products used as crosslinkers in one pass by means of the design variants of the multiple cascade die 1 shown in FIGS. 4.1, 4.2 and 4.3 to a backing substrate in web form. The flowable but chemically different at least two media 30 and 32 can be applied in combination with one another as individual layers in one pass, for example, S/B dispersions (styrene/butadiene dispersions), acrylates (dispersions), ethylene, vinyl acetate dispersions, polyurethane dispersions, wax emulsions or silicone emulsions as a release coat. Thus by virtue of the process proposed in accordance with the invention it is possible, for example, to apply a first, thin layer, for improving wettability, to a release coat.

### LIST OF REFERENCE NUMERALS

1 multiple cascade die
2 vessel section
3 hopper section
4 first exit cross section
5 second exit cross section
6 joint exit cross section
30 first flowable medium
31 film thickness of first flowable medium
32 second flowable medium
33 film thickness of second flowable medium
34 casting direction
35 flow direction
40 first backing substrate
41 second backing substrate
42 adhesive layer
43 barrier layer
50 third exit cross section
51 multilayer film
52 support wedge
53 supply line
54 takeoff direction
55 rotating curved surface
56 direction of rotation
57 flat face
58 support rounding
59 drop height
60 storage channel
61 channel aperture
62 middle section
63 first side section
64 second side section
65 bearing surface

What is claimed is:

1. A process for applying at least two chemically different flowable media, particularly aqueous solutions of polymers, dispersions or combinations thereof as adhesives and coating materials, or coatings, comprising the following steps:
a) applying at least two chemically different flowable media to web-form substrates continuously in one operation using a multiple cascade die (1),
b) the total amount of the multilayer application is between 2 g/m² to 200 g/m² and
c) the ratio of the individual layers within the multilayer application to one another is between 0.1 to 100.

2. A process as claimed in claim 1, used to laminate composite films and high-gloss films or to render web-form substrates, particularly paper or film, adhesive.

3. A process as claimed in claim 1, used to coat web-form substrates such as paper, polymeric films or metallized surfaces, the layer facing the surface acting to improve the adhesion or as a barrier coat.

4. A process as claimed in claim 1, used to paint substrates to jointly apply thereto elastic and hard layers in one pass.

5. A process as claimed in claim 1, wherein two layers of cationic and anionic polymers are applied which on layering tend toward gelling or coagulation.

6. A process as claimed in claim 5, wherein the two layers are a combination of cationic polymer solutions with anionic dispersions.

7. A process as claimed in claim 1, using solutions of polyvalent metal salts or metal complexes with polymer dispersions.

8. A process as claimed in claim 1, wherein in one of the chemically different layers polyisocyanate, polyepoxides or polyacyridines are combined with another layer which comprises dispersions.

9. A process as claimed in claim 8, in relation to solutions of reactive products used as crosslinkers.

10. A process as claimed in claim 1, wherein chemically different dispersions are applied as individual layers in one operation such as styrene-butadiene dispersions, acrylate, ethylene, vinylacetate dispersions and polyurethane dispersions, wax emulsions or silicone emulsions as release coat (antistick layer).

11. A process as claimed in claim 10, wherein a first thin layer serves to improve wettability on the release coat.
